(19) United States
(12) Patent Application Publication
(10) Pub. No.: US 2005/0007661 A1
(43) Pub. Date: Jan. 13, 2005

(54) Rectifying viewer

(76) Inventor: Damian Leneghan, Skerries (IE)

Correspondence Address: Porter Wright Morris & Arthur;Intellectual Property Department, 28th Floor, 41 South High Street, Columbus, OH, 43215-6194, US

(21) Appl. No.: 10/498,246

(22) PCT Filed: Oct. 8, 2002
(86) PCT No.: PCT/EP02/11333

(30) Foreign Application Priority Data
Oct. 8, 2001 (GB) 0124095.1

(51) Int. Cl. G02B 23/08; G02B 23/22

(52) U.S. Cl. 359/402

(57) ABSTRACT

The present invention relates to a viewer (10), and in particular a viewer which enables the convenient viewing of a plurality of separate, narrow images which are arranged in series, the individual images being disposed in a direction substantially perpendicular to the direction in which the series of images is arranged, for example the titles of a plurality of books stacked on a shelf, the viewer (10)comprising a housing (12) in which a first (18) and second mirror (20) are mounted in operative alignment with one another such that, an image reflected from the first mirror towards the second mirror is turned through an angle of between 60° C.-120° C. in a first plane, the image then being reflected by the second mirror through an angle of between 60° C.-120° C. in a second plane, which second plane is substantially perpendicular to the first plane.

The present invention relates to a viewer, and in particular a viewer which enables the convenient viewing of a plurality of separate, narrow images which are arranged in series, the individual images being disposed in a direction substantially perpendicular to the direction in which the series of images is arranged. The viewer achieves this result by projecting a reflection of the plurality of images in a direction which can be viewed by a person without any unnatural positioning/craning of the neck/head, which normally results in some level of discomfort, generally increasing in proportion to the length of time spent craning the neck/head.

Generally, books, CDs, DVDs, videos and the like are stacked in an upright position on shelves, for example in a library, book shop, or a video or music shop. Stacking in this manner enables such objects to be positioned having their spines facing outwards such that the titles printed thereon may be read. This form of stacking enables a relatively large number of such products to be stored/displayed in any given space, but does have one major drawback, which directly affects the consumer wishing to peruse the products with a view to purchasing/borrowing one or more of same. Due to the narrow, elongate nature of the spines of the various products mentioned above, the titles are generally printed in a direction running parallel to a longitudinal axis thereof. Therefore, when proceeding along the length of such a display/shelf stacked with these products, in order to conduct a review of the titles, or to pick a particular title from the shelf or the like, one must tilt and hold one's head at an angle in order to read the titles, thereby craning the neck. Craning of the neck to achieve such an angle obviously causes discomfort. In particular, when browsing through a section in a library/book shop or the like, where rather large displays/shelving are present, a considerable length of time is spent with one's head held at an angle in order to read the titles. The discomfort experienced may well cause the person to abandon their search, and in commercial enterprises, this results in a loss of revenue due to an abandoned purchase.

In addition, and compounding the above mentioned problem, is the particular difficulty in seeking to view books stacked, for example, at or below waist level, for example on lower shelves. In order to view these lower displays, it is generally necessary to crouch down in some manner, in order to view the titles sufficiently, and to then crane one's neck as hereinbefore described, which it will be appreciated is an extremely uncomfortable position, and cannot generally be maintained for more than a short period of time, again reducing the likelihood that a person will find the product they are looking for, again resulting in a failed purchase.

It is therefore an object of the present invention to mitigate one or more of the above mentioned problems associated with reviewing large numbers of horizontally stacked items.

It is a further object of this invention to provide a viewer for reading a plurality of images which are arranged in series, the individual images being orientated/readable in a direction substantially perpendicular to the direction in which the series of images is arranged.

It is a further object of this invention to provide such a viewer which may be releasably mounted, in sliding engagement, to a shelf or the like, in order to allow the viewer to be slid along the length of the shelf in a position allowing the images to be viewed without craning of the neck/head.

Therefore, according to the present invention, there is provided a viewer comprising a first reflector; a second reflector in operative alignment with the first reflector, such that an image reflected from the first reflector towards the second reflector is turned through an angle of between 60°-120° in a fit plane, the image then being reflected from the second reflector through an angle of between 60°-120° in a second plane, which second plane is substantially perpendicular to the first plane.

Preferably, the viewer comprises a body to which the first and second reflectors are mounted.

Preferably, the body comprises a housing within which the first and second reflectors are mounted, the housing having a first aperture enabling an image to enter the housing such as to be reflected by the first reflector towards the second reflector, and a second aperture enabling the image to emerge from the housing having been reflected by the second reflector.

Preferably, the body comprises a first section and a second section movable relative to the first section.

Preferably, the viewer further comprises at least one lens arranged to enable the image to be focused.

Preferably, the viewer comprises a first lens and a second lens in operative alignment with the first and second reflectors respectively.

Preferably, the second reflector may be hinged relative to the first reflector, in order to alter the direction in which the image is reflected from the second reflector.

Preferably, the first section and the second section are telescopically engaged.

Preferably, the viewer comprises a handle extending from the body.

Preferably, the viewer includes a coupling enabling the body to be attached to a suitable support.

Preferably, the coupling enables the viewer to be pivotable relative to the support

Preferably, the coupling enables the viewer to be slidably mounted to the support.

Preferably, the viewer comprises a light source arranged, in use, to illuminate the images to be read.

As used herein, the term “reflector” is intended to mean any object capable of reflecting an image, and may be for example a mirror, prism or the like, but is not intended to be limited to such devices, and could, for example, be formed by the deposition of a reflective metallized layer onto a suitable substrate.

As used herein, the term “coupling” is intended to mean any arrangement enabling a first object to be coupled to a second object, and may be, for example, a bracket, clip, stud or the like, and is particularly intended to embrace any arrangement which permits a first object, in particular a viewer according to the invention, to be slidably engaged to a second object, in particular a shelf or the like.

Embodiments of the invention will now be described by way of example only, with reference to the accompanying drawings in which:

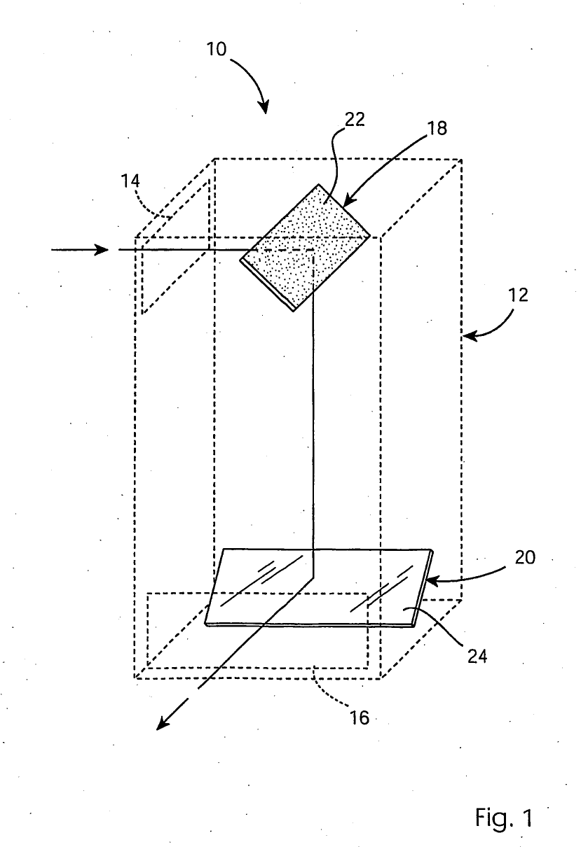

FIG. 1 is a perspective view of a viewer according to a first embodiment of the invention;

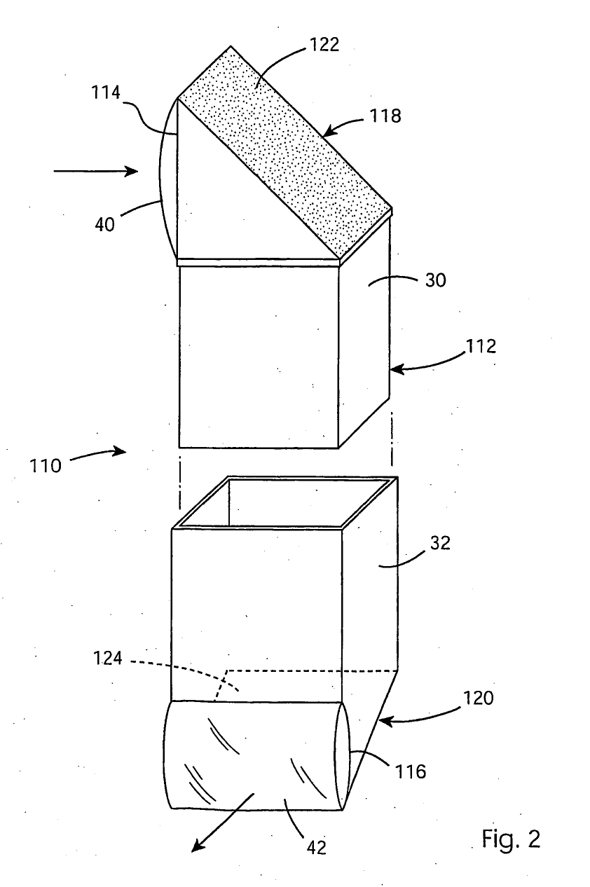

FIG. 2 is a perspective view of a viewer according to a second embodiment of the invention;

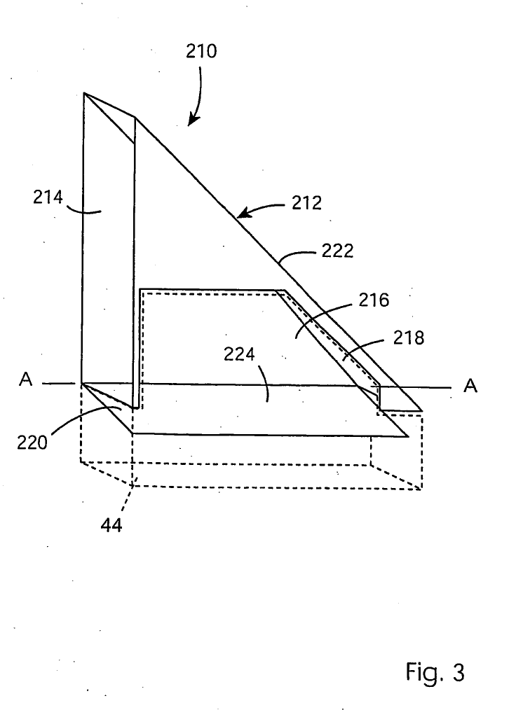

FIG. 3 is a perspective view of a viewer according to a third embodiment of the invention; and

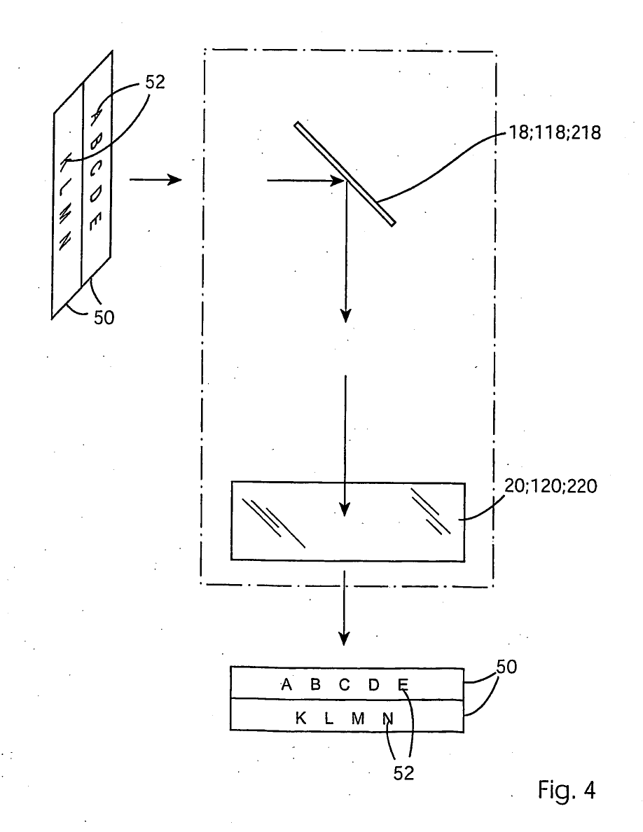

FIG. 4 is a schematic drawing showing how an image is rotated using the viewer of FIGS. 1, 2 and 3.

Referring now to FIG. 1 there is illustrated a first embodiment of a viewer according to the present invention, the viewer generally being indicated as 10. The viewer 10 comprises a body in the form of a substantially elongate generally square section housing 12, a general outline of which is shown by the dotted lines. It will be appreciated that the dotted lines indicate that the housing 12 may be of any suitable shape, as will become apparent from the following description of the invention, the shape illustrated merely being one particular example thereof The housing 12 is preferably comprised of plastic or the like, but it will be appreciated that it may be made of any other suitable material, for example sheet metal folded into the desired shape; moulded carbon fibre; or even a rigid frame wrapped in any suitable material or fabric to form a composite shell.

A first aperture 14 and a second aperture 16 are provided in the housing 12, the apertures 14, 16 being substantially rectangular in shape, which shape however is not essential to the operation of the invention, and is merely the preferred shape for the apertures 14, 16. The apertures 14, 16 permit an image to respectively enter and exit the housing 12, as will be described hereinafter in detail. The first aperture 14 and second aperture 16 are in substantially perpendicular planes to one other, as illustrated in FIG. 1. A first reflector in the form of a first mirror 18, and a second reflector in the form of a second mirror 20, are each mounted within the housing 12, and are positioned and orientated such that the image entering the housing 12 through the first aperture 14 is reflected off the first mirror 18 (only a rear 22 thereof being visible) towards a reflective surface 22 of the second mirror 20, which then reflects the image out of the housing 12 through the second aperture 16. Each of the first and second apertures 14, 16 are preferably provided with some form of transparent window or cover (not shown) therein, for example formed from glass, perspex, etc, in order to prevent the ingress of material, for example dust, into the housing 12, which might otherwise damage the mirrors 18, 20, or reduce the efficacy thereof.

Referring briefly to FIG. 4, the viewer 10, and in particular the position and orientation of the first and second mirrors 18, 20, is such that an image entering the viewer 10 through the first aperture 12, and exiting via the second aperture 14, is rotated through approximately 90° in a first plane by reflection off the first mirror 18, and is then rotated by approximately 90° in a second plane which is substantially perpendicular to the first plane, by reflection off the second mirror 20. These directional translations change the orientation of the image from one that runs, in use, vertically from top to bottom, to one that runs, in use, horizontally from left to right, thereby rendering the image readable without requiring tilting/craning of one's neck. It will be appreciated that the foregoing use of the words “vertically” and “horizontally” are merely indicative of the direction that an image will, in the majority of applications, respectively enter and leave the viewer 10, and that a change in the orientation of an image entering the viewer 10 will result in a change in the orientation of the image exiting the viewer 10. It is these directional translations that the image undergoes as it passes through the housing 12, reflecting off the first and second mirrors 18, 20, that embodies the invention, as opposed to the particular configuration of the viewer 10, which may be of any suitable configuration that performs the required translations of the image, as will be described in greater detail hereinafter.

Thus, referring now to FIG. 2, there is illustrated a second embodiment of the viewer according to the present invention, generally indicated as 110, which differs in shape and configuration to the viewer 10, but performs the same essential translations of an image viewed thereby. In this second embodiment, like components have been accorded like reference numerals, and unless otherwise stated, perform a like function. A housing 112 of the viewer 110 comprises a first section 30 and a second section 32. Both the first and second sections 30, 32 are substantially elongate and both have a generally square cross-sections, although it will of course be understood, as hereinbefore described, that the particular shape of the housing 112 is not essential to the operation of the invention. The housing 112 is again preferably formed from plastic, which may easily be moulded into the desired shape, and provides a lightweight yet tough and resilient body for the viewer 110.

Mounted within the first and second sections 30, 32 are respective first and second mirrors 118, 120. The mirrors 118, 120 are located within the housing 112 at approximately the same locations as the mirrors 18, 20 are located within the housing 12 of FIG. 1. The viewer 110 has a first aperture 114 located in the first section 30, and a second aperture 116 located in the second section, in register, respectively, with the first and second mirrors 118, 120. Again the purpose of the first and second apertures 114, 116 is to permit an image to enter and leave the housing 112, as hereinbefore described with reference to the viewer 10.

The first aperture 114 is provided with a first lens 40 in register therewith, while the second aperture 116 is provided with a second lens 42 in register therewith. The first and second lenses 40, 42 are an optional feature, and are adapted to either enlarge or reduce the image being read by the viewer 110. As an alternative, it will be appreciated that a lens (not shown) could, for example, be placed between the first and second mirrors 118, 120 in order to enlarge the image as it is reflected from the first mirror 118 to the second mirror 120. In addition, such a lens could be mounted within the housing 112 such that the lens could be moved towards and/or away from one or other of the first and second mirrors 118, 120, in order to alter the magnification experienced by the image.

Returning to the housing 112, the second section 32 is shaped and dimensioned to receive the first section 30. In this manner, the viewer 110 is telescopic in nature, as the housing 112 may be extended or retracted as desired, by means of the first and second sections 30, 32. The first section 30 may be slideably engaged within the second section 32 and movable from a retracted state in which the first section 30 is housed substantially within the second section 32, to an extended state in which the first section 30 projects substantially outwardly from the second section 32. The telescopic effect of the viewer 110 enables titles/products stacked on high shelves or in other awkward to reach areas to be easily viewed. It will be appreciated that such a telescopic effect may be achieved be any other suitable means, for example, the second section 32 may be slideably engaged within the first section 30.

Referring now to FIG. 3, there is illustrated a third embodiment of the viewer according to the present invention, generally indicated as 210, which again differs in shape and configuration to the viewer 10; 110, but performs the essential translations of any image viewed thereby. The viewer comprises a body in the form of a housing 212 which is substantially triangular in profile, and is again preferably formed from a plastic material. The housing 212 defines a first aperture 214 along one lateral face thereof, and a second aperture 216 in a front face thereof. The first and second apertures 214, 216 are preferably provided with some form of clear cover or window (not shown) in register therewith, as hereinbefore described with reference to the viewer 10.

The viewer 210 is provided with a first mirror 218 seated against the sloping side of the housing 212, on the interior thereof, the first mirror 218 being oppositely disposed the first aperture 214. Thus the rear 222 of the first mirror 218 is disposed in face to face contact with the housing 212. Both the first aperture 214 and the first mirror 218 are elongate in length relative to the width thereof, such as to conform to the general shape of the images to be viewed, thereby ensuring that the entire image may be captured by the viewer 210. The viewer 210 is also provided with a second mirror 220 adjacent the second aperture 216, and disposed relative to the first mirror 218 such that an image reflected from the first mirror 218 will be reflected off a reflective surface 224 of the second mirror 220 and exit the housing 212 via the second aperture 216, as hereinbefore described with reference to the viewer 10, 110.

The second mirror 220 is hingedly mounted, relative to the housing 212, along line AA, such that the angular inclination of the second mirror 220 can be varied, thereby altering the angle at which the image exits the second aperture 216. It will therefore be appreciated that the ability to vary the angular inclination of the second mirror 220 enables the viewer 210 to be used by persons of different height, or alternatively to use the viewer 210 to read images disposed at different heights, for example books (not shown) located on a higher or lower shelf (not shown). Consequently, the viewer 210 is provided with a clear cover 44 depending from the housing 212, and which extends to cover the second aperture 216, thereby protecting the second mirror 220. The cover 44 must extend for a distance below the second mirror 220 in order to allow same to be hinged about the line AA, without being hindered by the cover 44. The second mirror 220 may be hinged by any suitable conventional means, for example a simple shaft and corresponding dial arrangement (not shown).

Referring now to FIG. 4, there is illustrated a schematic drawing of how an image may be translated by means of the viewer 10;110;210 of FIGS. 1, 2 and 3 respectively. A pair of spines 50 illustrated exemplify spines of any of books, CDs, DVDs (not shown) or the like. The spines 50 are substantially elongate and titles 52 are printed along the length thereof, in use, in a substantially vertical direction from top to bottom, as hereinbefore described.

In use, therefore, the viewer 10;110;210 is arranged such that an image of the spines 50 enters the first aperture 14;114;214 as is clear from FIGS. 1, 2 and 3. It will be appreciated that the spines 50 generally face the first aperture 14;114;214 directly—the spines 50 are shown at an angle to the first aperture 14;114;214 in FIG. 4 for illustrative purposes to show the titles 52 present thereon. The image is reflected by substantially 90° in a first plane by the first mirror 18;118;218, having entered the housing 12;112;212 through the first aperture 14;114;214. This reflected image is directed towards the second mirror 20;120;220 where it is then reflected by substantially 90° in a second plane by the second mirror 20; 120;220. The first and second planes are substantially perpendicular to one another. In this manner, the mirrors 18;118;218, 20;120;220 enable an image entering the first aperture 14;114;214 of the viewer 10;110;210 to be translated/rotated twice through 90°. The final rotated image exits through the second aperture 16;116;216 as shown in FIG. 4, and is viewed by a user of the viewer 10;110;210.

Each of the viewers 10;110;210 may be provided with a number of addition features, as required, in order to improve or simply the use thereof. For example, a coupling (not shown) or the like may be provided in operative association with the viewer 10;110;210, preferably mounted to the housing 12;112;212. The coupling would enable the viewer 10;110;210 to be attached to, for example, a trolley (not shown) or similar carriage, in order to support the viewer 10;110;210, and render same mobile. It will therefore be appreciated that the trolley (not shown) would be wheeled along a row of books or the like, with a person simply viewing the image projected from the second aperture 16;116;216 of the housing 12;112;212.

Alternatively, the viewer 10;110;210 may simply be provided with a handle (not shown), preferably extending from the housing 12;112;212, thereby allowing the viewer 10;110;210 to be carried by a person as they travel along a row or shelf of books or the like, holding the viewer 10;110;210 such that the first aperture 14;114;214 faces the row of books and in particular the titles 52 printed thereon. In order to view the titles 52, therefore, the user views the second aperture 16;116;216 located at the front of the viewer 10;110;210. It is therefore not necessary to crane one's neck to view the titles 52.

It will be appreciated that the viewer 10;110;210 may be pivoted about the point at which the viewer 10;110;210 is attached to the trolley by means of the coupling (not shown). Therefore, if desired, the viewer 10;110;210 may also be used as follows. The viewer 10;10;210 is initially utilized in the manner as hereinbefore described, walking alongside a row of stacked spines 50. When the user reaches the end of a row, the viewer 10;110;210 may be pivoted about the coupling by approximately 180°. The user then moves to the opposite side of the trolley, and then proceeds to walk back alongside the row. This arrangement enables the user to view titles 52 stacked on a lower shelf.

As a further alternative, a coupling (not shown) may be provided in operative association with the viewer 10;110;210, preferably mounted to the housing 12;112;212, which permits the viewer 10;110;210 to be slidably mounted to a slideway (not shown) or the like. Said slideway could then be mounted to, or alternatively formed integrally with, a longitudinal outer edge of a shelf or similar display stand on which books, etc. are stacked. Thus the viewer 10;110;210 would be held in the correct position, relative to the titles 52, by the slideway, and the viewer 10;110;210 could then simply be slid along the slideway in order to view the various titles 52.

It will be seen that the invention is not limited to the embodiments described and that variations are possible.

For example, any suitable number of mirrors (not shown) may be included in the viewer 10;110;210. Additional mirrors (not shown) may enable a second aperture (not shown) of the viewer 10;110;210 to be located on the viewer 10;110;210 opposite the first aperture 14;114;214. Also, it will be appreciated that the housing 12;112;212 of the viewer 10;110;210 may be adapted to include any number of first apertures (not shown) and second apertures (not shown) enabling the viewer 10;110;210 to view images in many different locations as desired.

It will be further apparent that the present invention is not limited to the use of mirrors. For example, prisms (not shown) may be used in the viewer 10;110;210 instead of, or in combination with, the mirrors 18; 118;218, 20;120;220. As an additional alternative, some form of reflective material could be deposited onto a suitable substrate, for example the relevant portion of the housing 12;112;212. This may be achieved by conventional deposition of a reflective metallized layer. Also, any suitable number of lenses, as well as different sized lenses (not shown) may be used in the viewer 10;110;210. The lenses, for example those shown in FIG. 2, may have a magnifying or diminishing effect, depending on their use. The lenses may therefore not only be used to focus the image, but they may also enable a more compact construction of the housing 12;112;212. It will be appreciated that the mirrors 18;118;218, 20;120;220 are not required to be fixed in position, and if desired, may be pivotable about a point, to further increase their use.

In addition, the viewer 10;110;210 may be provided with one or more light sources (not shown) arranged to illuminate the titles 52 to be viewed, thereby improving the quality/intensity of the image exiting the second aperture 16;116;216. The light source may be a conventional light bulb, but is preferably some form of low power light source such as an array of LED's or the like, which could be powered by a battery (not shown) located on or within the housing 12;112;212.

1. A viewer comprising a first reflector; and a second reflector in operative alignment with the first reflector, such that an image reflected from the first reflector towards the second reflector is turned through an angle of between 60°-120° in a first plane, the image then being reflected by the second reflector through an angle of between 60°-120° in a second plane, which second plane is substantially perpendicular to the first plane.

2. A viewer according to claim 1 comprising a body to which the first and second reflectors are mounted.

3. A viewer according to claim 2 wherein the body comprises a housing within which the first and second reflectors are mounted, the housing having an aperture enabling an image to enter the housing such as to be reflected by the first reflector towards the second reflector, and a second aperture enabling the image to emerge from the housing following reflection by the second reflector.

4. A viewer according to claim 2 wherein the body comprises a first section and a second section movable relative to the first section.

5. A viewer according to claim 1 wherein the viewer further comprises at least one lens arranged to enable the image to be focused.

6. A viewer according to claim 5 comprising a first lens and a second lens in operative alignment with the first and second reflectors respectively.

7. A viewer according to claim 1 wherein the second reflector is hinged relative to the first reflector, in order to alter the direction in which the image is reflected from the second reflector.

8. A viewer according to claim 4 wherein the first and second sections are telescopically engaged.

9. A viewer according to claim 2 comprising a handle extending from the body.

10. A viewer according to claim 2 comprising a coupling enabling the body to be attached to a suitable support.

11. A viewer according to claim 10 wherein the coupling enables the viewer to be pivotable relative to the support.

12. A viewer according to claim 10 wherein the coupling enables the viewer to be slidably mounted to the support.

13. A viewer according to claim 1 comprising a light source arranged, in use, to illuminate the images to be read.

14. A viewer according to claim 3 wherein the body comprises a first section and a second section movable relative to the first section.

15. A viewer according to claim 1 comprising a first lens and a second lens in operative alignment with the first and second reflectors respectively.
